(19) United States
(12) Patent Application Publication
(10) Pub. No.: US 2025/0285232 A1
(43) Pub. Date: Sep. 11, 2025

(54) Neural Network Adapters for Versatile Image Restoration

(71) Applicant: MediaTek Inc., Hsinchu City (TW)

(72) Inventors: Yu-Syuan Xu, Hsinchu City (TW); Hao-Wei Chen, Hsinchu City (TW)

(21) Appl. No.: 19/037,163

(22) Filed: Jan. 25, 2025

Related U.S. Application Data
(60) Provisional application No. 63/562,717, filed on Mar. 8, 2024.

(51) Int. Cl. G06T 5/60

(52) U.S. Cl. CPC G06T 5/60

(57) ABSTRACT

A neural network restores a low-quality (LQ) image having a given degradation type. The neural network includes a series of adapter layers, each adapter layer including a pre-trained module in parallel with an adapter module. The pre-trained module has been trained in a pre-training phase by images having multiple degradation types, and the adapter module has been trained in a fine-tuning phase subsequent to the pre-training phase by images having the given degradation type. In each adapter layer, a first output of the pre-trained module and a second output of the adapter module are added together to produce an output of the adapter layer. The neural network generates a high-quality (HQ) image restored from the LQ image based on outputs of the adapter layers.

### CROSS-REFERENCE TO RELATED APPLICATIONS

This application claims the benefit of U.S. Provisional Application No. 63/562,717 filed on Mar. 8, 2024, the entirety of which is incorporated by reference herein.

### TECHNICAL FIELD

Embodiments of the invention relate to image restoration using neural networks.

### BACKGROUND OF THE INVENTION

Image restoration is an image processing technique that reconstructs high-quality (HQ) images from degraded low-quality (LQ) counterparts. The field of image restoration has witnessed substantial progress with the emergence of deep-learning approaches. Current methods achieve considerable success by training tailored models, each for a single task of restoring a specific degradation. These single-task methods are confined to the degradations present during the training phase, resulting in limited generalizability. Furthermore, the single-task methods entail considerable storage costs and computational overheads due to their reliance on task-specific deep-learning networks.

Straightforward strategies for multi-task image restoration involve directly training a shared model on multiple degradations. The multi-task methods enhance the versatility of the trained network and reduce the storage costs of multiple single-task models. However, these methods have limited generalizability to degradations beyond those included in the training set. Thus, there is a need for developing flexible and cost-efficient methods for image restoration.

### SUMMARY OF THE INVENTION

In one embodiment, a method is provided for image restoration. The method starts with receiving an LQ image having a given degradation type. A neural network processes the LQ image. The neural network includes a series of adapter layers, each adapter layer including a pre-trained module in parallel with an adapter module. The pre-trained module has been trained in a pre-training phase by images having a plurality of degradation types, and the adapter module has been trained in a fine-tuning phase subsequent to the pre-training phase by images having the given degradation type. The method further comprises the steps of: in each adapter layer, adding a first output of the pre-trained module and a second output of the adapter module to produce an output of the adapter layer, and generating an HQ image restored from the LQ image based on outputs of the adapter layers.

In another embodiment, a system is operative to perform image restoration. The system includes processors and memory to store parameters of a neural network that includes a series of adapter layers, each adapter layer including a pre-trained module in parallel with an adapter module. One or more of the processors are operative to perform the aforementioned method of image restoration.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1A, FIG. 1B, and FIG. 1C illustrate a high-level view of an image restoration framework with different input degradations according to some embodiments.

FIG. 2 is a block diagram illustrating an instantiation of an image restoration framework according to one embodiment.

FIG. 3 is a block diagram illustrating an example of an adapter layer according to one embodiment.

FIG. 4 is a block diagram illustrating an example of an adapter module according to one embodiment.

FIG. 5 is a block diagram illustrating a system operative to perform image restoration according to one embodiment.

FIG. 6 is a flow diagram illustrating a method for image restoration according to one embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The disclosure herein describes a flexible and cost-efficient image restoration framework, which integrates compact, task-specific adapter modules into a foundation model, thereby enabling the generalization of the foundation model to multiple specific image restoration tasks. The disclosed framework further enables low storage cost and efficient training without sacrificing the performance of image restoration. The foundation model may be a generic image restoration network that includes multiple interconnected neural network blocks. These neural network blocks, also referred to as pre-trained modules, can be trained in a self-supervised pre-training phase using synthetic degradations of multiple degradation types. Subsequent to the pre-training phase is a fine-tuning phase, in which a set of adapter modules are trained for a specific degradation type. The fine-tuning phase may be repeated to train multiple sets of adapter modules, each set trained to restore a corresponding degradation type in input images. The adapter modules are lightweight and task-specific modules that can be efficiently trained and stored. The pre-training phase aims to uncover sharable components, while the fine-tuning phase facilitates easy adaptation to different tasks.

The benefits of parameter-efficient tuning are at least twofold. Firstly, the relationship between various restoration tasks is difficult to discern when training a single multitask model from scratch. The two-phase transfer learning mechanism allows for learning shareable components during the pre-training phase. Model designers can analyze pre-training schemes and investigate the generalizability of the pre-trained modules. Secondly, efficient fine-tuning enables the lightweight, task-specific adapter modules to target the degradations not covered in the pre-training phase, thereby reducing memory and computational time.

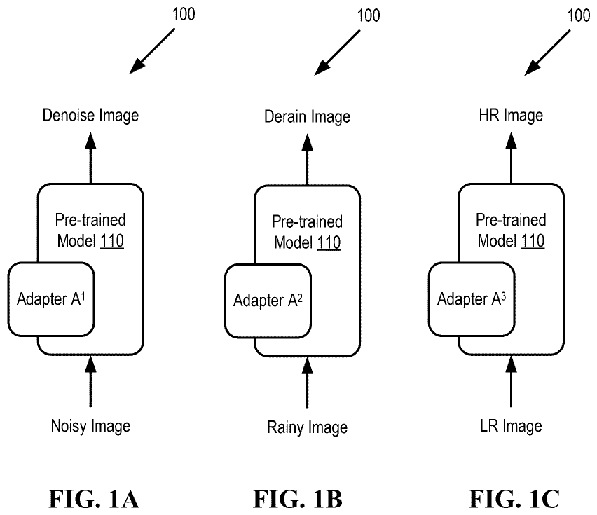

FIG. 1A, FIG. 1B, and FIG. 1C illustrate a high-level view of an image restoration framework 100 with different input degradations according to one embodiment. The image restoration framework 100 is operable to recover high-quality (HQ) images I_{HQ}^{r}∈R^{H×W×3} from a corresponding low-quality (LQ) images I_{LQ}^{r}∈R^{H×W×3}, where r∈{1, 2, 3, . . . , R} denotes the index of the restoration task and R represents the total number of restoration tasks, with H and W referring to the height and width of the images, respectively. As non-limiting examples, FIG. 1A, FIG. 1B, and FIG. 1C illustrate the image restoration tasks of denoising, de-raining, and super-resolution, respectively. The adapter modules A¹, A² and A³ are integrated into pre-trained modules 110 and are tuned for task-specific image restoration. The tuning is efficient as the parameters of the pre-trained module 110 stay unchanged during the fine-tuning phase.

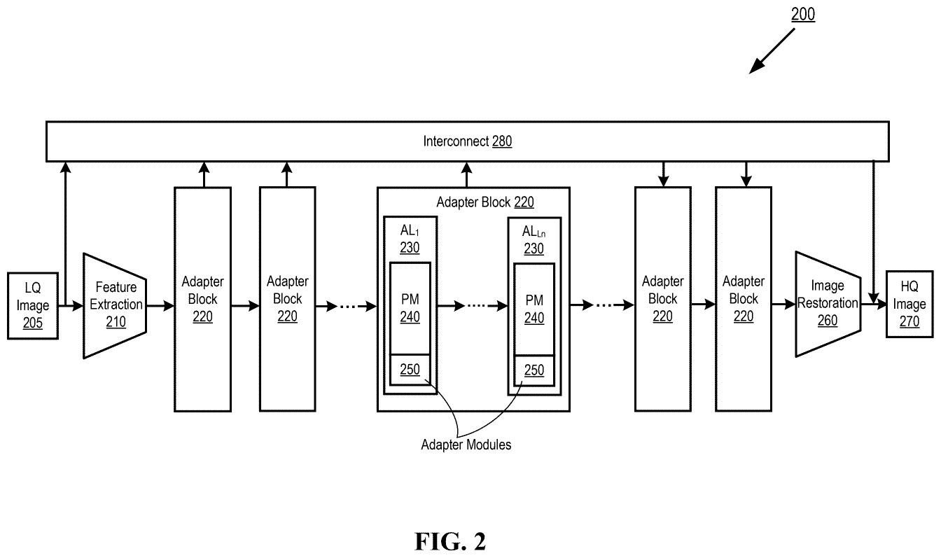

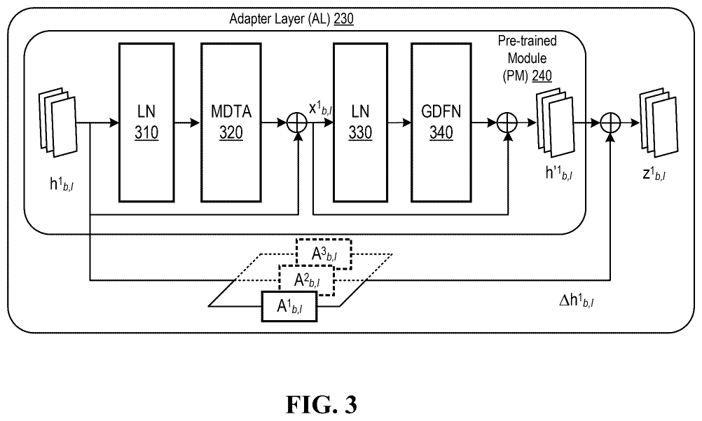

FIG. 2 is a block diagram illustrating an instantiation of the image restoration framework 100 according to one embodiment. In this example, the image restoration framework 100 is instantiated as a neural network 200. An input image (e.g., an LQ image 205) is initially projected into a latent embedding space through a feature extraction module 210, e.g., a 3×3 convolutional layer. The output of the feature extraction module 210 is referred to as feature embedding. The feature embedding is processed by a series of adapter blocks 220, each of which includes a series of adapter layers 230 (e.g., AL₁, AL₂, . . . , AL_{Ln}). Each adapter layer 230 includes a pre-trained module 240 coupled to an adapter module 250. The pre-trained module 240 is pre-trained for handling multiple different image restoration tasks. One example of the pre-trained module 240 is shown in FIG. 3. In one embodiment, the adapter blocks 220 are interconnected by an interconnect 280. The structure and/or operations of the interconnect 280 may depend on the foundation model chosen by the network designers.

In one embodiment, each adapter block 220 has a multi-level hierarchical encoder-decoder structure. In each adapter block 220, the series of adapter layers 230 first progressively reduces the spatial resolution and then incrementally upscales the spatial resolution until the spatial resolution of the resulting image matches that of the input image. The output of the last adapter block 220 is processed by an image restoration module 260, which may include a convolutional layer to produce a restored HQ image 270.

To facilitate the learning of task-specific knowledge, the adapter module 250 is incorporated into each adapter layer 230. The adapter module 250 includes convolutional layers to integrate nearby pixel information for restoration effectively. When the LQ image 205 is identified to have a given degradation type, the adapter module 250 trained for the given degradation type is activated to generate a residual output, which is then added to the output of the corresponding pre-trained module 240. Integrating the adapter module 250 into the pre-trained module 240 provides the flexibility needed for the restoration framework to adapt to different tasks, improving its overall performance and versatility.

FIG. 3 is a block diagram illustrating an example of the adapter layer 230 according to one embodiment. As shown in FIG. 3, each adapter layer 230 includes the pre-trained module 240 and multiple adapter modules 250 (e.g., A_{b,l}¹, A_{b,l}², A_{b,l}³). Only one of the adapter modules 250 that has been trained to restore the input LQ image's degradation type is activated (shown in the solid outline). The adapter module 250 operates to adapt the pre-trained module 240 to a specific image restoration task. The pre-trained module 240 is the core module of a foundation model, an example of which is the Restormer model described in Zamir, S. W., et al.: Restormer: Efficient transformer for high-resolution image restoration. In: Proc. IEEE Conf. on Computer Vision and Pattern Recognition (CVPR). pp. 5718-5729 (2022), which is incorporated by reference herein. It is understood that in an alternative embodiment, a different neural network may be used as the foundation model.

In one embodiment, the pre-trained module 240 is the core module in the aforementioned Restormer, which includes interconnected transformer blocks. Each Restormer-based pre-trained module 240 includes a multi-DConv head transposed attention (MDTA) 320, a gated-DConv feed-forward network (GDFN) 340, and two layers of layer normalization (LN) 310, 330. Operations of MDTA 320, GDFN 340, and LN 310, 330, are described in the aforementioned Restormer publication. The features (e.g., the feature embedding) processed by the pre-trained modules 240 in two different adapter blocks 220 may have different sizes in one or more dimensions. For example, the feature size of a first adapter block may be H×W×C, where H, W, and C represent height, width, and channel of the feature embedding, respectively. The feature size of a second adapter block may be (H/s) x (W/s)× (sC), where s is a scalar such as 2, 4, 8, etc. In some embodiments, LN and nonlinear functions may be omitted from the pre-trained module 240.

Referring to FIG. 3, in the pre-trained module 240, an input h_{b,l}^{r} is processed through LN 310 and MDTA 320, where index b={1, 2, . . . n, . . . , N} denotes the adapter block 220, index l={1, 2, . . . , L_{b}} denotes the adapter layer 230 in the adapter block 220, and index r denotes the restoration task corresponding to the adapter modules 250. In the example of FIG. 3, r=1. The output of MDTA 320 is combined with the original input h_{b,l}^{r} to form the feature x_{b,l}^{r}. This feature then passes through another LN 330 and GDFN 340 with a residual connection to create h_{b,l}^{r}′. More specifically, the operation of the pre-trained module 240 is described as follows:

$${x}_{b , l}^{r} = {h}_{b , l}^{r} + MDTA ( {h}_{b , l}^{r} ) , and$$

$${h}_{b , l}^{′ r} = {x}_{b , l}^{r} + GDFN ( {x}_{b , l}^{r} ) .$$

It is understood that the pre-trained module 240 in FIG. 3 is a non-limiting example. In alternative embodiments, the pre-trained module 240 may have a different structure and/or perform different operations from what is shown in FIG. 3. In one embodiment, the image restoration framework 100 (FIG. 1A-FIG. 1C) may use U-Net as the foundation model. An example of U-Net is described in Ronneberger et al., U-Net: Convolutional networks for biomedical image segmentation, Medical Image Computing and Computer-Assisted Intervention (MICCAI). pp. 234-241 (2015), which is incorporated by reference herein.

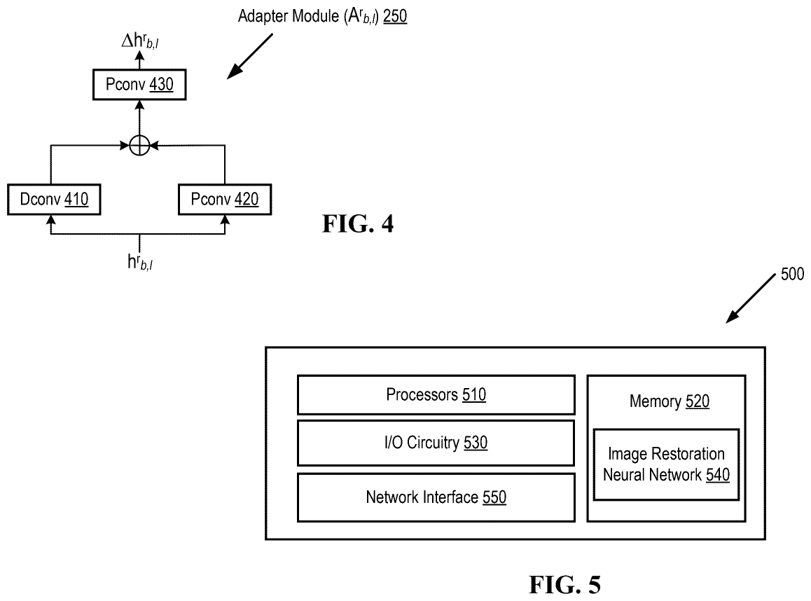

FIG. 4 is a block diagram illustrating an example of the adapter module 250 according to one embodiment. The adapter module 250 has a multi-branch structure including a depth-wise convolution layer (DConv) 410 and two pointwise convolution (PConv) layers 420, 430. In one embodiment, DConv 410 applies a 3×3 kernel to each depth (e.g., channel) dimension of the DConv input, and each PConv 420, 430 applies a 1×1 kernel to the PConv input. The kernel dimensions are denoted herein by height×width according to the conventional representation. It is understood that a precise representation of the kernel dimensions is: (number of input channels)×height×width×(number of output channels).

In one embodiment, each adapter module 250 (A_{b,l}^{r}) is connected in parallel to a corresponding pre-trained module 240 in the same adapter layer 230, and receives the same input h_{b,l}^{r} as the corresponding pre-trained module 240. The input h_{b,l}^{r} passes through DConv 410 and PConv 420 in parallel, and the outputs of 410 and 420 are added together. This sum is processed by PConv 430 to produce the output of the adapter module Δh_{b,l}^{r}. The output of the adapter module Δh_{b,l}^{r} is then added to the output of the pre-trained module 240 h′_{b,l}^{r} to produce the adapted output z_{b,l}^{r} of the adapter layer 230.

The overall operation of an adapter layer ALₗ is described as follows:

$$Δ {h}_{b , l}^{r} = {A}_{b , l}^{r} ( {h}_{b , l}^{r} ) = PConv ( Dconv ( {h}_{b , l}^{r} ) + PConv ( {h}_{b , l}^{r} ) ) , and$$

$${z}_{b , l}^{r} = {h}_{b , l}^{′ r} + Δ {h}_{b , l}^{r}$$

Referring to FIG. 2, in one embodiment, the neural network 200 is trained using a two-phase training strategy. In the pre-training phase, a self-supervised training strategy is used to enhance the generalizability of the neural network 200 to restoring LQ input images. This strategy involves the generation of training pairs by augmenting ground truth images with various synthetic distortions, thereby creating a self-supervised learning environment. The pre-trained modules 240 are trained in the pre-training phase to extract features from a diverse array of degraded input images and to reduce artifacts therein. The adapter modules 250 are trained during the fine-tuning phase to fine-tune task-specific parameters to meet the unique challenges of each restoration task. In the fine-tuning phase, only the parameters within the adapter modules 250 are trained, while the pre-trained module 240 remains unchanged. This two-phase approach allows for efficient training of the restoration framework 100.

After fine-tuning, a single copy of the foundation model (which includes the pre-trained modules 240 in all of the adapter blocks 220) can be stored alongside multiple lightweight adapter modules 250. This setup facilitates the restoration of images affected by various types of degradations without necessitating multiple large-scale models, thereby reducing both storage requirements and computational complexity.

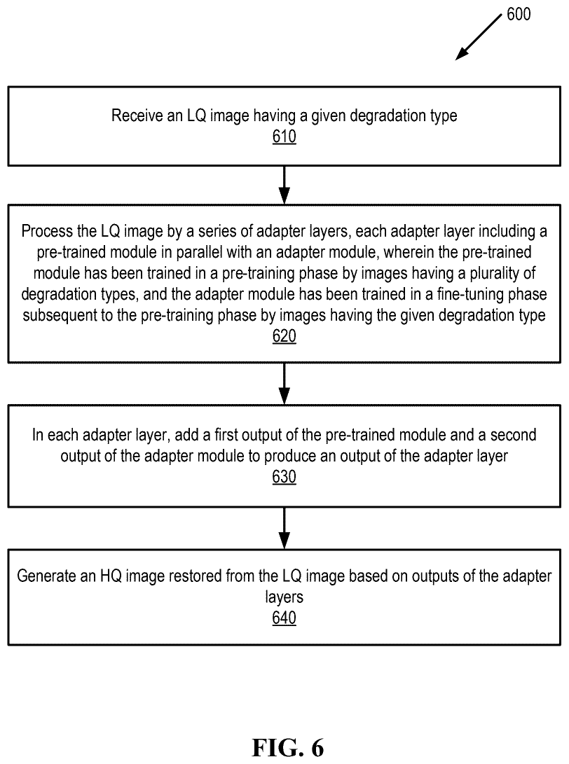

FIG. 5 illustrates an example of a system 500 operative to perform image restoration according to one embodiment. In this example, the system 500 includes multiple processors 510 such as a central processing unit (CPU), a graphics processing unit (GPU), a neural processing unit (NPU), a multimedia processor, a digital signal processor, and other general-purpose and/or special-purpose processing circuitry. The processors 510 may perform the operations of method 600 in FIG. 6.

The system 500 further includes a memory 520. The memory 520 may include one or more of a dynamic random-access memory (DRAM) device, a static RAM (SRAM) device, a flash memory device, and/or other volatile or non-volatile memory devices. In one embodiment, the memory 520 stores instructions executable by the processors 510 to perform image restoration, such as instructions for an image restoration neural network 540. An example of the image restoration neural network 540 is the neural network 200 in FIG. 2. Although memory 520 is shown as one block in FIG. 5, it is understood that memory 520 may include multiple memory devices at multiple memory hierarchies.

The system 500 may further include I/O circuitry 530 to receive input and display output. In one embodiment, the system 500 may further include network interfaces 550 for accessing wired and/or wireless networks. It is understood that the system 500 is simplified for illustration; additional hardware and software components are not shown.

FIG. 6 is a flow diagram illustrating a method 600 for image restoration according to one embodiment. The method 600 may be performed by a system such as the system 500 in FIG. 5, or another computing system. In one embodiment, the method 600 starts with step 610 in which the system receives an LQ image having a given degradation type. At step 620, the system processes the LQ image by a series of adapter layers, each adapter layer including a pre-trained module in parallel with an adapter module. In each adapter layer, the pre-trained module has been trained in a pre-training phase by images having a plurality of degradation types, and the adapter module has been trained in a fine-tuning phase subsequent to the pre-training phase by images having the given degradation type. At step 630, in each adapter layer, the system adds a first output of the pre-trained module and a second output of the adapter module to produce an output of the adapter layer. At step 640, the system generates an HQ image restored from the LQ image based on outputs of the adapter layer.

In one embodiment, the system performs convolution operations on an output of a last adapter layer in the series of adapter layers; and adds the LQ image to an output of the convolution operations to obtain the HQ image. In one embodiment, the adapter module in each adapter layer includes a first pointwise convolution layer (PConv) connected in parallel to a depth-wise convolution layer (DConv), and respective outputs of the first PConv and the DConv are added together and processed by a second PConv to produce the second output.

In one embodiment, the parameters of the pre-training module in each adapter layer stay unchanged in the fine-tuning phase. In one embodiment, the adapter module in each adapter layer is deactivated in the pre-training phase.

In one embodiment, multiple sets of adapter modules are trained in the finetuning phase, each set trained to restore a corresponding degradation type in input images. In one embodiment, each of the multiple sets of adapter modules is trained to restore one of the plurality of degradation types. In another embodiment, one of the multiple sets of adapter modules is trained to restore a new degradation type for which the pre-trained module in each adapter layer has not been trained.

In one embodiment, the system identifies the given degradation type of the LQ image, and activates corresponding adapter modules in each adapter layer that are trained in the fine-tuning phase for the given degradation type. In one embodiment, the series of adapter layers are grouped into a plurality of adapter blocks, and the adapter modules in different adapter blocks have different feature sizes in one or more dimensions.

The operations of the flow diagram of FIG. 6 have been described with reference to the exemplary embodiment of FIG. 5. However, it should be understood that the operations of the flow diagram of FIG. 6 can be performed by embodiments of the invention other than the embodiment of FIG. 5, and the embodiment of FIG. 5 can perform operations different than those discussed with reference to the flow diagram. It is understood that the order of operations shown in the flow diagram of FIG. 6 is a non-limiting example. Alternative embodiments may perform the operations in a different order, combine certain operations, overlap certain operations, etc.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for image restoration, comprising:
receiving a low-quality (LQ) image having a given degradation type;
processing the LQ image by a neural network that includes a series of adapter layers, each adapter layer including a pre-trained module in parallel with an adapter module, wherein the pre-trained module has been trained in a pre-training phase by images having a plurality of degradation types, and the adapter module has been trained in a fine-tuning phase subsequent to the pre-training phase by images having the given degradation type;
in each adapter layer, adding a first output of the pre-trained module and a second output of the adapter module to produce an output of the adapter layer; and
generating a high-quality (HQ) image restored from the LQ image based on outputs of the adapter layers.

2. The method of claim 1, further comprising:
perform convolution operations on an output of a last adapter layer in the series of adapter layers; and
add the LQ image to an output of the convolution operations to obtain the HQ image.

3. The method of claim 1, wherein the adapter module in each adapter layer includes a first pointwise convolution layer (PConv) connected in parallel to a depth-wise convolution layer (DConv), and respective outputs of the first PConv and the DConv are added together and processed by a second PConv to produce the second output.

4. The method of claim 1, wherein parameters of the pre-training module in each adapter layer stay unchanged in the fine-tuning phase.

5. The method of claim 1, wherein the adapter module in each adapter layer is deactivated in the pre-training phase.

6. The method of claim 1, further comprising:
training multiple sets of adapter modules in the finetuning phase, each set trained to restore a corresponding degradation type in input images.

7. The method of claim 6, wherein each of the multiple sets of adapter modules is trained to restore one of the plurality of degradation types.

8. The method of claim 6, wherein one of the multiple sets of adapter modules is trained to restore a new degradation type for which the pre-trained module in each adapter layer has not been trained.

9. The method of claim 1, further comprising:
identifying the given degradation type of the LQ image; and
activating corresponding adapter modules in each adapter layer that are trained in the fine-tuning phase for the given degradation type.

10. The method of claim 1, wherein the series of adapter layers are grouped into a plurality of adapter blocks, and the adapter modules in different adapter blocks have different feature sizes in one or more dimensions.

11. A system for image restoration, comprising:
a plurality of processors; and
memory to store parameters of a neural network that includes a series of adapter layers, each adapter layer including a pre-trained module in parallel with an adapter module, wherein one or more of the processors are operative to:
receive a low-quality (LQ) image having a given degradation type;
process the LQ image by each of the adapter layers, wherein the pre-trained module in each adapter layer has been trained in a pre-training phase by images having a plurality of degradation types, and the adapter module in each adapter layer has been trained in a fine-tuning phase subsequent to the pre-training phase by images having the given degradation type;
in each adapter layer, add a first output of the pre-trained module and a second output of the adapter module to produce an output of the adapter layer; and
generate a high-quality (HQ) image restored from the LQ image based on outputs of the adapter layers.

12. The system of claim 11, wherein the one or more of the processors are operative to:
perform convolution operations on an output of a last adapter layer in the series of adapter layers; and
add the LQ image to an output of the convolution operations to obtain the HQ image.

13. The system of claim 11, wherein the adapter module in each adapter layer includes a first pointwise convolution layer (PConv) connected in parallel to a depth-wise convolution layer (DConv), and respective outputs of the first PConv and the DConv are added together and processed by a second PConv to produce the second output.

14. The system of claim 11, wherein parameters of the pre-training module in each adapter layer stay unchanged in the fine-tuning phase.

15. The system of claim 11, wherein the adapter module in each adapter layer is deactivated in the pre-training phase.

16. The system of claim 11, wherein multiple sets of adapter modules are trained in the finetuning phase, each set trained to restore a corresponding degradation type in input images.

17. The system of claim 16, wherein each of the multiple sets of adapter modules is trained to restore one of the plurality of degradation types.

18. The system of claim 16, wherein one of the multiple sets of adapter modules is trained to restore a new degradation type for which the pre-trained module in each adapter layer has not been trained.

19. The system of claim 11, wherein one or more of the processors are further operative to:
identify the given degradation type of the LQ image; and
activate corresponding adapter modules in each adapter layer that are trained in the fine-tuning phase for the given degradation type.

20. The system of claim 11, wherein the series of adapter layers are grouped into a plurality of adapter blocks, and the adapter modules in different adapter blocks have different feature sizes in one or more dimensions.
